(19) United States
(12) Patent Application Publication
(10) Pub. No.: US 2010/0075181 A1
(43) Pub. Date: Mar. 25, 2010

(54) SOLID-STATE STRUCTURE COMPRISING A BATTERY AND A VARIABLE CAPACITOR HAVING A CAPACITANCE WHICH IS CONTROLLED BY THE STATE-OF-CHARGE OF THE BATTERY

(75) Inventors: Rogier Adrianus Henrica Niessen, Eindhoven (NL); Petrus Henricus Laurentius Notten, Eindhoven (NL); Johannes Hubertus Gerardus Op Het Veld, Eindhoven (NL); Remco Henricus Wilhelmus Pijnenburg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,233

(22) PCT Filed: Nov. 29, 2007
(86) PCT No.: PCT/IB07/54837

§ 371 Date: Jun. 2, 2009

(30) Foreign Application Priority Data
Dec. 4, 2006 (EP) 06125303.5

(51) Int. Cl. H01M 12/00

(52) U.S. Cl. 429/9

(57) ABSTRACT

The present invention relates to a solid-state variable capacitor, comprising a first capacitor plate (10), a second capacitor plate (12), extending substantially parallel to the first capacitor plate (10) and on a distance from said first capacitor plate, wherein at least the first capacitor plate (10) is structurally coupled to one side of a first layered solid-state battery wherein the layers (4-8) of said first solid-state battery (3) extend substantially parallel to the first capacitor plate (10) and wherein the first solid-state battery is susceptible to variations in the size in the direction perpendicular to the plane of its layers (4-8). This invention is based on the realization that the thickness of a solid-state battery (3) varies with conditions prevailing in the battery. The movable capacitor plate (10) causes a change of the capacitance value of the capacitor.

### FIELD OF THE INVENTION

Presently, many variations of possible integrated capacitors are utilized in IC design. However, depending on the electrical circuit it is often desirable that at least some of these capacitors are not of constant value, but are variable or tunable. Currently, controllable capacitors based on MEMS technology exist. These are the microscopic equivalent of air-spaced variable capacitors and can be integrated into silicon chips using conventional wafer fabrication processes. In these devices the capacitance value can be tuned in a continuous manner by applying, for example, a DC voltage across a beam/membrane structure.

### BACKGROUND OF THE INVENTION

Although controllable or tunable MEMS capacitors are widely investigated, these devices employ freestanding beams or membranes that are prone to collapse or get stuck in a “closed” state. This can result from poor processing during the under-etching of the beams or after the application of too high a DC voltage across the beam structure, resulting in over-stressing and subsequent sticking On average, the freestanding parts in MEMS tunable capacitors can deflect up to a certain threshold, generally up to about 75% of the original gap size for a membrane. If exceeded, collapse or sticking will occur, rendering the device useless.

The change in capacitance value is dependent on the geometry of the MEMS design, but is always limited by the fact that the ratio between the “low” and “high” capacitance state is rather small for devices with a small footprint, that is the surface area used on the substrate. Only for, for example, very long beams and thus a large surface area, this ratio can be substantially higher.

Additionally, in order to be able to tune/switch the aforementioned MEMS devices a continuously applied high DC voltage is needed in the order of 10-50 V.

Novel concepts, like 3D integration of all-solid-state rechargeable thin film Li-ion batteries were previously described in document WO2005/027245A2. Generally, these power sources can be used for many applications such as implantables, sensors and autonomous devices. However, it has appeared to the inventors that these battery stacks can also be advantageously used in the creation of a fully tunable capacitor.

This invention is based on the realization that the thickness of a solid-state battery varies with conditions prevailing in the battery. When one side of such a stacked solid-state battery is fixed and a capacitor plate is connected to the other side thereof, said capacitor plate moves when the charge condition of the battery is changed, resulting in a change of the capacitance value of the capacitor. The second capacitor plate may be fixed or may be subject of a similar structure for changing its position. Consequently a kind of electrochemically tunable capacitor is obtained.

The present invention provides a solid-state variable capacitor, comprising: a first capacitor plate; a second capacitor plate, extending substantially parallel to the first capacitor plate and on a distance from said first capacitor plate; wherein at least the first capacitor plate is structurally coupled to one side of a first layered solid-state battery wherein the layers of said first solid-state battery extend substantially parallel to the first capacitor plate and wherein the first solid-state battery is susceptible to variations in the size in the direction perpendicular to the plane of its layers.

This novel capacitor has no freestanding parts as in the prior art, so the problems of sticking or collapse of such parts is avoided by the invention.

Utilizing the electrochemically tunable capacitor disclosed in this document, a wide range for capacitance values are attainable. The maximum ratio between the “low” and “high” capacitance state can be very high. This can be achieved by changing the chemistry within the battery stack to yield a stack that expands/contracts substantially upon charging/discharging. This will not result in a significant surface area enlargement or footprint and will therefore be much less space-consuming as a tunable MEMS capacitor employing a very long freestanding beam as forms part of the prior art.

Finally, switching in the electrochemically tunable capacitor described in this document only requires a low voltage of 1-5 V and a low current. This is substantially less than the aforementioned prior art MEMS structures.

### SUMMARY OF THE INVENTION

A preferred embodiment provides a variable capacitor of the kind referred to above wherein the solid-state variable capacitor comprises a battery cathodic electrode layer deposited on a substrate, a solid electrolyte layer deposited on the battery cathodic electrode layer, a battery anodic electrode layer deposited on the solid electrolyte layer, a dielectric layer deposited on the battery anodic layer, the first capacitor plate provided on the dielectric layer, the second capacitor plate and wherein at least one of the electrode layers has the property that its thickness varies with the density of the active species in the at least one electrode.

This embodiment makes use of the fact that the variation of thickness of the battery stack is substantially attributable to the electrode layers thereof and in particular with the concentration of the active species in said electrode layers, allowing to optimize the design of the battery stack to the required capacitor properties by careful selection and design of the electrode layers. Herein it is noted that the electrode layers are understood to comprise the current collector layers often used in battery stacks of this kind. It will however be clear that the volume of the current collector is substantially constant and that the volume of the electrode itself will vary under the influence of the prevailing conditions, like the concentration of the active species.

Preferably such a capacitor is obtained by a method for producing a solid-state variable capacitor with a first capacitor plate and a second capacitor plate extending substantially parallel to the first capacitor plate on a distance from said first capacitor plate, wherein at least the first capacitor plate is structurally coupled to one side of a first layered solid-state battery structure of which the size in the direction perpendicular to the plates is variable, the method comprising the steps of providing a substrate, deposition of a battery cathode layer on the substrate, deposition of a solid electrolyte layer on the battery cathode layer, deposition of a battery anode layer on the solid electrolyte layer, deposition of a dielectric layer on the battery anode layer, deposition of the first capacitor plate on the dielectric layer and provision of the second capacitor plate. This method provides a simple way of constructing the structure for a capacitor according to the invention, wherein use is made of technologies common in the field of production of solid-state batteries. It will be clear that also in this method the application of the electrode layers is understood to comprise the relevant current collector layers as well.

Although it is possible to obtain the required variation of the thickness of the battery stack through different layers, it appears that the materials which are preferably used as the battery anode show the most variation in thickness under the influence of the concentration of the active species. Consequently a preferred embodiment provides the feature that the first solid-state battery has an anodic electrode comprising a material chosen such that the thickness of the anodic electrode varies with the concentration of the active species in said anode. It is however by no means excluded that the variable thickness of the battery stack is obtained through use of appropriate materials in other layers, either on its own, or in combination with similar features in other layers. Further it is noted that due to the migration of the active species between the electrodes, expansion of one electrode may well be accompanied by contraction of the other electrode. However when one of these effects is substantially stronger than the other a contraction or expansion of the battery stack as a whole results.

A further preferred embodiment provides the feature that the active species in the solid state battery is formed by lithium (Li) and that the anode comprises an anode material chosen from the group of silicon (Si), tin (Sn), germanium (Ge), antimony (Sb), bismuth (Bi), zinc (Zn) or an alloy of these metals. It has appeared that the resulting combination yields attractive variations in the thickness of the anode layers.

Preferably, at least one electrode of the energy source according to the invention is adapted for storage of active species of at least one of following elements: hydrogen (H), beryllium (Be), magnesium (Mg), aluminium (Al), copper (Cu), silver (Ag), sodium (Na) and potassium (K), or any other suitable element which is assigned to group 1 or group 2 of the periodic table. So, the capacitor according to the invention may be based on various intercalation mechanisms and is therefore suitable to comprise different kinds of (reserve-type) batteries, e.g. Li-ion battery cells, NiMH battery cells, et cetera.

The structure according to the invention provides two different electrical circuits, that is the battery circuit and the capacitor circuit, wherein the battery circuit is used to control the capacitance value of the capacitor. It is attractive to make the control circuit independent from the capacitor circuit. To provide such independence yet another preferred embodiment provides the feature that between said first capacitor plate and the first solid-state battery a dielectric layer is present. This layer provides a proper separation of the capacitor electrode from the battery anode often including the current collector layer connected thereto.

Preferably the dielectric layer is made of a material having a low relative dielectric constant. This provides an even better separation between the battery or control circuit and the capacitor circuit.

Preferably the dielectric material is doped SiO₂, porous SiO₂, polymers (PVDF, PS, PE), or polymethylsilsesquioxane.

According to a first preferred structural embodiment the capacitor structure referred to above may be doubled to obtain the combined variation in distance of the capacitor plates and hence of the capacity of the capacitor. Such a doubled structure is obtained when the second capacitor plate is structurally coupled to one side of a second solid-state layered battery, the layers of said second solid-state battery extend substantially parallel to the second capacitor plate and the second solid-state battery is susceptible to variations in the size in the direction perpendicular to the plane of its layers. The structure described by this claim comprises two batteries and a single capacitor, wherein the capacitance of the capacitor is dependant on the charge condition in each of the batteries.

A capacitor according to such a structural embodiment is preferably obtained by a method which is executed in a substrate with a deep trench structure and wherein subsequently to the formation of the stack of layers, the stack of layers at the bottom of the trench is removed. This is a technique proven to be advantageous in the field of batteries.

The removal of the stack of layers at the bottom of the trench is preferably performed by chemical mechanical polishing or wet chemical etching, as these techniques are well known techniques in the processing of integrated circuits.

The production of such a structure is simplified when the first and the second batteries have structures which are mirrored relative to the centre of the middle plane of the first and the second capacitor plates. This reduction is obtained by the effects of symmetry. Consequently preferably the method is symmetrically executed in a substrate with a deep trench structure.

Preferably the first and second batteries are connected to separate control circuits, offering the possibility for a dual control of the capacitance of the capacitor. An example is to use one of the batteries for coarse control of the capacity and the other battery for fine tuning thereof. This is especially attractive if the materials and geometry of the structure are chosen accordingly.

Yet another preferred embodiment provides a variable capacitor which is composed of a plurality of variable capacitors of the kind referred to above wherein the capacitor plates of said capacitors are mutually connected. These features allows to construct capacitors with larger capacities. Further it allows to adapt the structure of the capacitor to the available space on the substrate, as it allows to separate the capacitor structure into separate units. Yet another advantage which can be obtained by this feature is the fact that the capacitance can be independently controlled by more than two batteries, offering new control possibilities.

Mutual connection between the plates of the different capacitor plates offers the possibility to connect the first capacitor plates to the second capacitor plates, offering a single capacitor having a higher capacitance value.

It is however also possible to connect the capacitor plates into a switchable network allowing to connect the capacitors in a series connection or in a parallel connection. This offers the possibility to make a voltage multiplication circuit by charging the capacitors in parallel and discharging them in series. Although this circuit is known per se, the invention allows it to be incorporated in a solid-state circuit in its entirety.

A second structural embodiment provides the feature that the first and the second capacitor plates have been formed on different substrates and the substrates have been united after the formation of the first and second capacitor plates. This embodiment is in particular effective in situations wherein one of the capacitor plates is fixed and the other plate is connected to the battery stack.

A special embodiment, which is independent from the structure provides the feature that the space between the first and the second plate has been enclosed and sealed from the environment and that the space has been filled with a gas, a liquid or vacuum. This allows a further possibility to design the capacitance of the capacitor. If a fluid is used, provisions must be taken to allow for the volumetric variation of the cavity due to the changeable position of the capacitor plates, for instance by providing a flexible membrane.

By patterning or structuring one, and preferably both, electrodes of the electrochemical energy source according to the invention, a three-dimensional surface area, and hence an increased surface area per footprint of the electrode(s), and an increased contact surface per volume between the at least one electrode and the electrolytic stack is obtained. This increase of the contact surface(s) leads to an improved effectiveness of the dependency of the capacitance from the charge condition. It is preferred that at least one surface of at least one electrode is substantially regularly patterned, and more preferably that the applied pattern is provided with one or more cavities, in particular pillars, trenches, slits, or holes, which particular cavities can be applied in a relatively accurate manner. In this manner the increased performance of the controllable capacitor can also be predetermined in a relatively accurate manner. In this context it is noted that a surface of the substrate onto which the stack is deposited may be either substantially flat or may be patterned (by curving the substrate and/or providing the substrate with trenches, holes and/or pillars) to facilitate generating a three-dimensional oriented capacitor. In this context it is noted that a surface of the substrate onto which the stack is deposited may be either substantially flat or may be patterned (by curving the substrate and/or providing the substrate with trenches, holes and/or pillars) to facilitate generating a three-dimensional oriented capacitor.

Preferably, each electrode comprises a current collector. By means of the current collectors the cell can easily be connected to an electronic device. Preferably, the current collectors are made of at least one of the following materials: Al, Ni, Pt, Au, Ag, Cu, Ta, Ti, TaN, and TiN. Other kinds of current collectors, such as, preferably doped, semiconductor materials such as e.g. Si, GaAs, InP may also be applied to act as current collector.

The capacitor preferably comprises at least one barrier layer being deposited between the substrate and at least one electrode, which barrier layer is adapted to at least substantially preclude diffusion of active species of the cell into said substrate. In this manner the substrate and the electrochemical cell will be separated chemically, as a result of which the performance of the electrochemical cell and hence of the capacitor can be maintained relatively long-lastingly. In case a lithium ion based cell is applied, the barrier layer is preferably made of at least one of the following materials: Ta, TaN, Ti, and TiN. It may be clear that also other suitable materials may be used to act as barrier layer.

In a preferred embodiment preferably a substrate is applied, which is ideally suitable to be subjected to a surface treatment to pattern the substrate, which may facilitate patterning of the electrode(s). The substrate is more preferably made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. Beside relatively rigid materials, also substantially flexible materials, such as e.g. foils like Kapton® foil, may be used for the manufacturing of the substrate. It may be clear that also other suitable materials may be used as a substrate material.

The invention also provides an electrical device comprising an electrochemical energy source as claimed in any of the preceding claims. Also in such an embodiment the fruitful effects of the invention appear very well.

Yet another embodiment provides the feature that the second capacitor plate is provided by flip-chipping a second substrate with a fixed capacitor plate on the assembly, leading to a particular attractive method for producing a capacitor according to the present invention.

### BRIEF DESCRIPTION OF THE DRAWINGS

Subsequently the present invention will be elucidated with the help of the accompanying drawings, wherein:

FIG. 1 shows a schematic perspective view of Li-battery in silicon substrate with the thin film trench structure;

FIG. 2 shows a schematic perspective view of a capacitor according to the invention with a battery with the structure of a single trench, wherein a complete stack is deposited;

FIG. 3 shows a schematic perspective view of the structure of a trench after the removal of the bottom of the trench by thinning the substrate;

FIGS. 4a and 4b show a schematic perspective view of the structure of a capacitor according to the invention, together with electrical connections, in different situations; and

FIGS. 5a and 5b show a schematic perspective view of the structure of a capacitor according to a second structural embodiment after the deposition process and after the flipping of the upper half of the chip respectively.

### DETAILED DESCRIPTION OF THE EMBODIMENTS

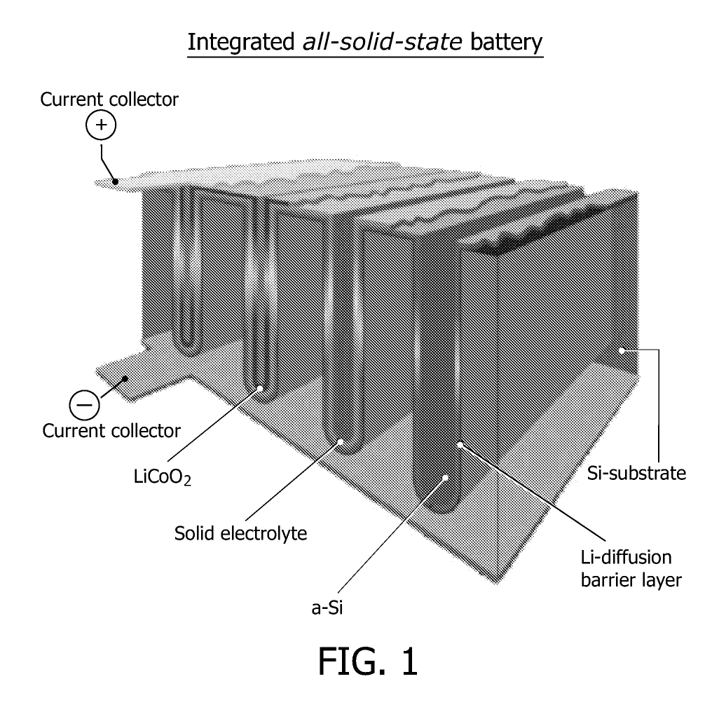

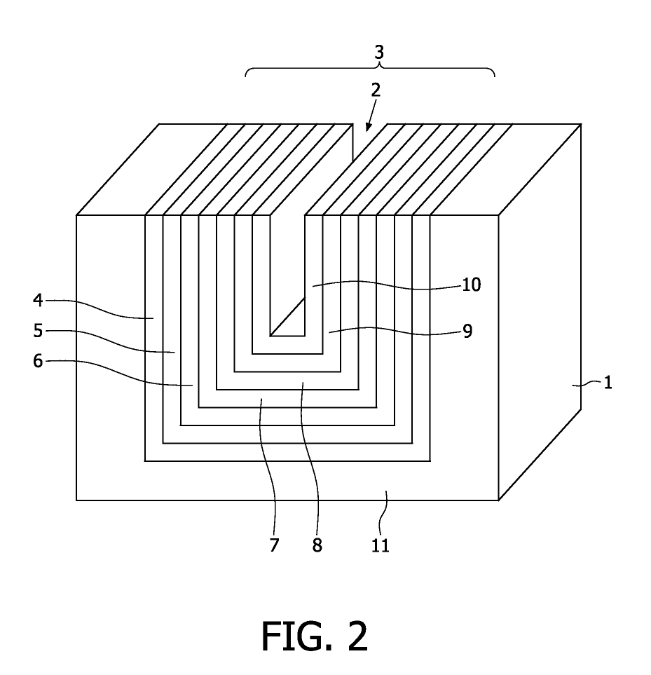

FIG. 1 shows the all solid-state thin film battery disclosed in document WO2005/027245A2. Using the deposition and integration technology described in this prior art document, a stack can be manufactured that can be used to make an electrochemically tunable capacitor. This stack is depicted in FIG. 2. In this figure a schematic representation is shown of a single trench in a substrate 1 in which a trench 2 is formed wherein a battery stack denoted in its whole by 3 is deposited according to the prior art method mentioned above.

This battery stack 3 applied on the substrate 1 comprises a current collector layer 4, a cathode layer 5, an solid-state electrolyte layer 6 and an anode layer 7. On top of the anode layer 7 a current collector layer 8 is deposited. On the thus formed battery stack 3 a dielectric layer 9 is deposited and thereon conductive layer 10, which will be used as the capacitor plate from the current collector layer 8. The dielectric layer 9 shields and insulates the conductive layer 10 from the current collector layer 8.

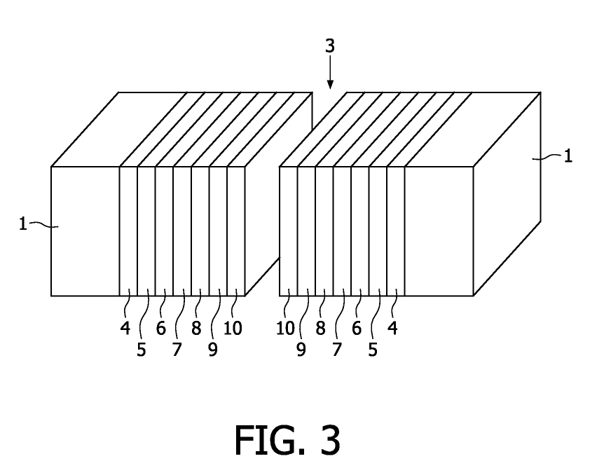

The next step in the manufacturing procedure would be to remove the stack 3 of layers at the bottom of the trench 2 in order to create two separate stacks 3 that are each other's mirror image. This is shown in FIG. 3. The simplest way to achieve this is to thin down the substrate 1, for example using chemical mechanical polishing (CMP) techniques or wet chemical etching, until the bottom 11 of the trench 2 is removed. Instead of using a substrate 1 with blind trenches 2 a substrate with via trenches can be used. In both cases a situation is obtained that is shown in FIG. 3. It is apparent that after removal of the bottom 11 of the trench 2 two individual stacks 3 remain that each consists of a battery stack 3, a capacitor plate 10, and a dielectric shielding layer 9 between said capacitor plate 10 and the anode current collector layer 8.

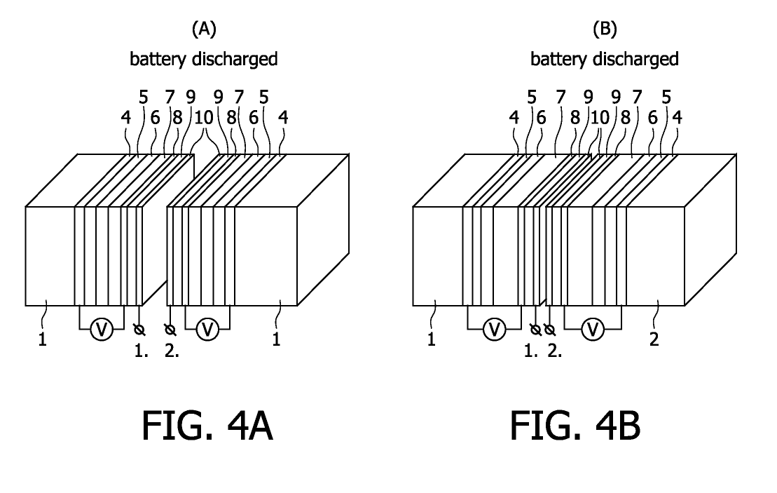

FIG. 4 schematically shows how charging or discharging the battery stack 3 can alter the capacitance value. Charging or discharging the battery stack 3 can be done galvanostatically or potentiostatically, generally needing a low voltage of 1 to 5 V depending on the battery electrode materials utilized. It is known from that a complete battery stack expands or contracts upon charging and discharging respectively. Depending in the exact battery electrode materials used in the stack the complete volume expansion can be reduced/minimized. However, this volume change can also be utilized for the aim of the present invention.

If battery electrode materials are chosen in such a way that the overall uni-axial expansion/contraction of the battery stack upon charging/discharging is large, the battery stack can be used as a moveable carrier for a capacitor plate. Suitable battery electrode materials with a very high volume expansion are mainly anode materials such as; Si, Sn, Ge, Pb, Sb, or Bi.

In the example shown in FIGS. 4a and 4b the battery stack 3 expands upon charging and contracts upon discharging. This effect is caused by the volumetric expansion of the anodes 7 due to the varying concentration of the active species within said anode. In the thin film technology used in the structure of the invention, this volumetric expansion or reduction results in a variation of the thickness of the electrodes, resulting in the movement of the capacitor plates. In the situation where the battery in is its discharged state the capacitor plates will have a large gap in between them, as shown in FIG. 4a. Charging the battery will result in uni-axial expansion of the battery stacks 3 on both sides of the trench 2 bringing the capacitor plates 10 closer to one another, as shown in FIG. 4b. The capacitance value can be measured and utilized at connection points 1 and 2. It should be noted that different combinations of battery electrode materials could be chosen that yield the opposite result!

It should be noted that in this design capacitive coupling exists between the capacitor plate 10 and the anode current collector 8. Therefore, the dielectric layer 9 between these is essential. In order to minimize this capacitive coupling this layer 9 should be quite thick as compared to the gap between both capacitor plates 10 as well as of low-k dielectric material, that the material with a low relative dielectric constant such a doped SiO₂, porous SiO₂, polymers (PVDF, PS, PE), or polymethylsilsesquioxane.

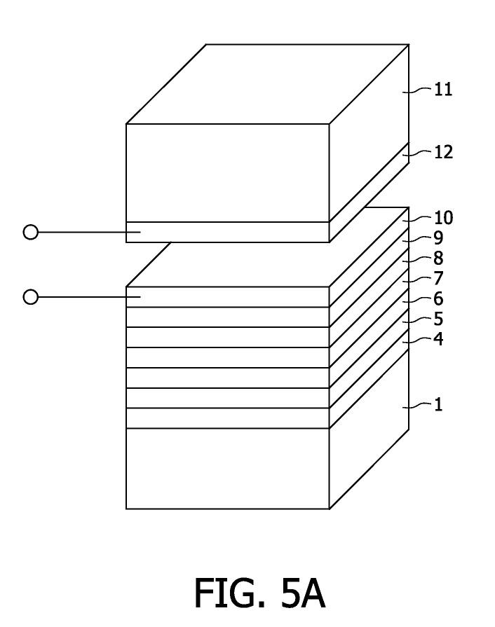

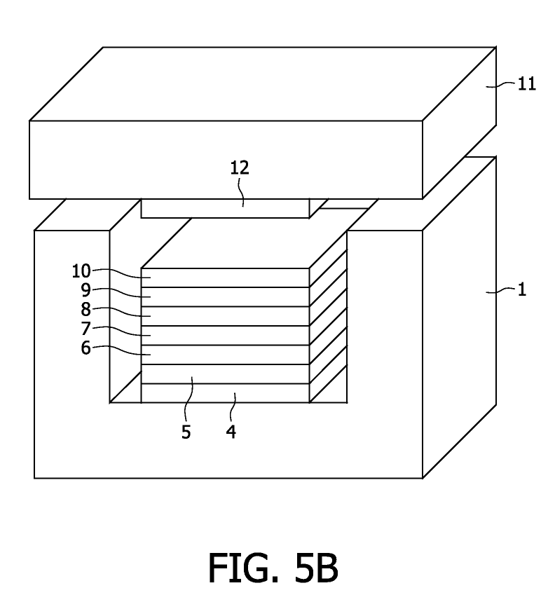

In FIGS. 2 to 4 a two-sided approach towards an electrochemically tunable capacitor is shown. In this device both capacitor plates 10 are movable. Alternatively, a single-sided approach might be opted for if manufacturing and/or integration is easier. This option is shown in FIGS. 5a and 5b. Both figures show a configuration wherein the lower capacitor plate 10 is moveable, whereas a capacitor plate 13 on the upper side is fixed. In FIG. 5a a configuration is shown which can be produced in a process similar to that of the FIGS. 2-4, although it may very well be produced by a planar process. However, the design shown in FIG. 5b might be manufactured by initially processing the full stack 3 on a wafer 1 in a planar fashion and subsequently flip-chipping a substrate 12 with the fixed capacitor plate 13 on top of this assembly.

Additionally, MEMS technology can be effectively utilized to manufacture cavities for the disclosed tunable capacitors. It should be noted that if the tunable capacitor is manufactured within a closed and sealed cavity, the cavity itself can be either filled with a gas, like (O₂, N₂, Ar) or be vacuum. This feature offers the possibility for a wider variation in capacitance as the medium between both capacitor plates also determines the capacitance value that can be obtained. It is noted that this last feature is applicable to both capacitors having the structure as disclosed in the FIGS. 2-4 and in those having the structure of FIG. 5, or in any other suitable configuration.

Further it is noted that apart from the embodiments shown in this document, the invention is also applicable to other configurations.

1. Solid-state variable capacitor, comprising:
a first capacitor plate;
a second capacitor plate, extending substantially parallel to the first capacitor plate and on a distance from said first capacitor plate;
wherein at least the first capacitor plate is structurally coupled to one side of a first layered solid-state battery wherein the layers of said first solid-state battery extend substantially parallel to the first capacitor plate; and
wherein the first solid-state battery is susceptible to variations in the size in the direction perpendicular to the plane of its layers.

2. Variable capacitor as claimed in claim 1, wherein the solid-state variable capacitor comprises:
a battery cathodic electrode layer deposited on a substrate;
a solid electrolyte layer deposited on the battery cathodic electrode layer;
a battery anodic electrode layer deposited on the solid electrolyte layer;
a dielectric layer deposited on the battery anodic electrode layer;
the first capacitor plate provided on the dielectric layer;
the second capacitor plate, and
that at least one of the electrode layers has the property that its thickness varies with the concentration of the active species in at least one of the electrodes.

3. Variable capacitor as claimed in claim 1, wherein the first solid-state battery has an anodic electrode of a material chosen so that the thickness of the anodic electrode varies with the concentration of the active species in said electrode.

4. Variable capacitor as claimed in claim 3, wherein the active species is lithium (Li) and that the anodic electrode layer comprises an anode material chosen from the group of silicon (Si), tin (Sn), germanium (Ge), antimony (Sb), bismuth (Bi), zinc (Zn) or an alloy of these materials.

5. Variable capacitor as claimed in claim 1, wherein at least one electrode of an energy source according to the invention is adapted for storage of active species of at least one of following elements: hydrogen (H), beryllium (Be), magnesium (Mg), aluminium (Al), copper (Cu), silver (Ag), sodium (Na) and potassium (K), or any other suitable element which is assigned to group 1 or group 2 of the periodic table.

6. Variable capacitor as claimed in claim 1, wherein between said first capacitor plate and the first solid-state battery a dielectric layer is present.

7. Variable capacitor as claimed in claim 6, wherein the dielectric layer has a low relative dielectric coefficient.

8. Variable capacitor as claimed in claim 7, wherein the dielectric material is doped SiO2, porous SiO2, polymers (PVDF, PS, PE), or polymethylsilsesquioxane.

9. Variable capacitor as claimed in claim 1, wherein the second capacitor plate is structurally coupled to one side of a second solid-state layered battery, wherein the layers of said second solid-state battery extend substantially parallel to the second capacitor plate and that the second solid-state battery is susceptible to variations in the size in the direction perpendicular to the plane of its layers.

10. Variable capacitor as claimed in claim 9, wherein the first and the second batteries have structures which are mirrored relative to the centre of the middle plane of the first and the second capacitor plates.

11. Variable capacitor as claimed in claim 9, wherein the first and the second batteries are connected to separate control circuits.

12. Variable capacitor, characterized by a plurality of variable capacitors as claimed in claim 1, and that at least some of the capacitor plates of each of said capacitors are mutually connected.

13. Variable capacitor as claimed in claim 12, wherein the first capacitor plates of said capacitors are mutually connected and that the second capacitor plates of said capacitors are mutually connected.

14. Variable capacitor as claimed in claim 12, wherein the capacitor plates are connected in a switchable network allowing to connect the capacitors in a series connection or in a parallel connection.

15. Variable capacitor as claimed in claim 1, wherein the first capacitor plate has been formed on a first substrate and the second capacitor plate has been formed on a second substrate and that the first and the second substrates have been united after the forming of the first and second capacitor plates.

16. Variable capacitor as claimed in claim 1 wherein the space between the first and the second plate has been enclosed and sealed from the environment and that the space has been filled with a gas, a liquid or vacuum.

17. Variable capacitor as claimed in claim 1, wherein at least one electrode is provided with at least one patterned surface.

18. Variable capacitor as claimed in claim 17, wherein the at least one patterned surface of the at least one electrode is provided with multiple cavities.

19. Variable capacitor as claimed in claim 18, wherein at least a part of the cavities form pillars, trenches, slits, or holes.

20. Variable capacitor as claimed in claim 1, wherein an anodic electrode and a cathodic electrode each comprise a current collector.

21. Variable capacitor as claimed in claim 20, wherein the at least one current collector is made of at least one of the following materials: Al, Ni, Pt, Au, Ag, Cu, Ta, Ti, TaN, and TiN.

22. Variable capacitor as claimed in claim 1, wherein an energy source further comprises at least one electron-conductive barrier layer being deposited between the substrate and at least one electrode, which barrier layer is adapted to at least substantially preclude diffusion of active species of the cell into said substrate.

23. Variable capacitor as claimed in claim 22, wherein the at least one barrier layer is made of at least one of the following materials: Ta, TaN, Ti, and TiN.

24. Variable capacitor according to claim 1, wherein the substrate comprises Si and/or Ge.

25. Variable capacitor according to claim 1, wherein a substrate is made of a flexible material, like Kapton® or a metal foil.

26. Electrical device, comprising at least one capacitor according to claim 1.

27. Method for producing a solid-state variable capacitor with a first capacitor plate and a second capacitor plate extending substantially parallel to the first capacitor plate on a distance from said first capacitor plate, wherein at least the first capacitor plate is structurally coupled to one side of a first layered solid-state battery structure of which the size in the direction perpendicular to the plates is variable with the state-of-charge of the battery, the method comprising the following steps:
deposition of a battery cathodic electrode layer on the substrate;
deposition of a solid electrolyte layer on the battery cathodic electrode layer;
deposition of a battery anodic electrode layer on the solid electrolyte layer;
deposition of a dielectric layer on the battery anodic electrode layer;
deposition of the first capacitor plate on the dielectric layer; and
provision of the second capacitor plate.

28. Method as claimed in claim 27, wherein the method is executed in a substrate with a deep trench structure and subsequently to the forming of the stack of layers removing the stack of layers in the bottom of the trench.

29. Method as claimed in claim 28, wherein the stack of layers at the bottom of the trench is removed by chemical mechanical polishing or wet chemical etching.

30. Method as claimed in claim 27, wherein the second capacitor plate is provided by flip-chipping a second substrate with a fixed capacitor plate on the assembly.

31. Variable capacitor according to claim 1, wherein the flexible material is Kapton® or a metal foil.
